(19) United States
(12) Patent Application Publication
(10) Pub. No.: US 2016/0365903 A1
(43) Pub. Date: Dec. 15, 2016

(54) DSDA AND MIMO ANTENNA SYSTEM

(71) Applicant: MOTOROLA MOBILITY LLC, Chicago, IL (US)

(72) Inventors: Istvan J. Szini, Grayslake, IL (US); Krishna K. Bellamkonda, Lake Zurich, IL (US); Brian H. Bremer, Arlington Heights, IL (US); John Peters, Virgil, IL (US); Brett Robertson, Mundelein, IL (US)

(21) Appl. No.: 14/739,226

(22) Filed: Jun. 15, 2015

(51) Int. Cl. H04B 7/04; H04B 1/00; H04W 8/18; H04B 1/3827; H04W 52/24

(52) U.S. Cl. CPC H04B 7/0426; H04B 1/3827; H04W 52/241; H04W 8/183; H04B 1/0057

(57) ABSTRACT

A mobile communication device has a first antenna and a second antenna wherein a primary subscriber identification module (“SIM”) is linked to the first antenna. The second antenna is shared between a secondary SIM transceiver path and a multiple-input, multiple-output (“MIMO”) transceiver path. A power splitter disposed in the secondary SIM transceiver path is configured to adaptively set a power split between the MIMO transceiver path and the secondary SIM transceiver path based on a current signal-to-noise ratio associated with the MIMO transceiver path.

### TECHNICAL FIELD

The present disclosure is related generally to mobile-device communication facilities and, more particularly, to a system and method for optimizing dual subscriber identification module (“SIM”), dual active (“DSDA”) and multiple input, multiple output (“MIMO”) connectivity.

### BACKGROUND

Two cooperative technologies are increasingly being employed to improve throughput and connectivity options in portable cellular devices. These cooperative technologies are DSDA transceiver systems and MIMO antenna systems. The current architecture for DSDA employs a secondary main antenna (associated with a second SIM receiver) and a MIMO secondary system. Typically, within this architecture, a signal received via the shared antenna is divided equally between the MIMO transceiver path and the second SIM transceiver path.

MIMO antenna-gain imbalance is a consideration with such systems. However, the inventors have found that in higher signal-to-noise ratio (“SNR”) conditions, e.g., in conditions where the SNR is greater than 12 dB, the MIMO antenna-gain imbalance has minimum or negligible effect on the overall MIMO radiated performance. Conversely, the MIMO antenna-system correlation coefficient strongly affects the radiated performance and resultant data throughput in high SNR conditions.

However, in low SNR conditions (e.g., conditions when the SNR is less than 6 dB) the correlation coefficient has almost no impact on the MIMO radiated performance, while the antenna-gain imbalance has a much larger impact. A MIMO system can provide either robustness (through diversity) or increased throughput (through spatial multiplexing). When in the diversity mode, the same outgoing signal is sent via both paths, and the same purported received signal is processed through both paths.

While the present disclosure is directed to a system that can eliminate some of the shortcomings noted in this Background section, it should be appreciated that any such benefit is not a limitation on the scope of the disclosed principles, or of the attached claims, except to the extent expressly noted in the claims. Additionally, the discussion of technology in this Background section is reflective of the inventors' own observations, considerations, and thoughts, and is in no way intended to accurately catalog or comprehensively summarize the prior art. As such, the inventors expressly disclaim this section as admitted or assumed prior art with respect to the discussed details. Moreover, the identification herein of a desirable course of action reflects the inventors' own observations and ideas and should not be assumed to indicate an art-recognized desirability. While SNR has been adopted as a figure of merit for present purposes, an example of an alternative figure of merit to use is the Channel Quality Indicator (“CQI”). Thus, in keeping with the disclosed principles, the CQI reported by the mobile device may instead be used to determine the optimal signal split ratio between antennas.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a simplified schematic of an example device with respect to which embodiments of the presently disclosed principles may be implemented;

FIG. 2 is a modular schematic of the device of FIG. 1 showing additional antenna-system components usable in implementing the disclosed principles;

FIG. 3 is a modular schematic of the device of FIG. 1 showing a more detailed view of antenna-system components usable in implementing embodiments of the disclosed principles;

FIG. 4 is a data diagram showing first and second power-splitting plots in accordance with embodiments of the disclosed principles;

FIG. 5 is a flowchart showing an example process of implementing a power split between transceiver paths in a DSDA MIMO antenna system within an embodiment of the described principles; and

FIG. 6 is an illustration of an example lookup table that may be used in an embodiment of the disclosed principles.

### DETAILED DESCRIPTION

Before presenting a detailed discussion of embodiments of the disclosed principles, an overview of certain embodiments is given to aid the reader in understanding the later discussion. As noted above, within the current architecture for DSDA, a received signal is divided equally between the MIMO transceiver path and second SIM transceiver path. However, this architecture leads to suboptimal performance given the common treatment of the antenna-gain imbalance and antenna-system correlation coefficient regardless of SNR conditions.

In an embodiment, a variable power splitter controlled based on MIMO SNR detection is used, with the splitting ratio being higher in higher SNR conditions favorable to the second SIM receiver. This improves the host device's over-the-air (“OTA”) performance, without degradation of MIMO performance, since the power-split ratio does not affect the correlation coefficient. In lower SNR conditions the power split is equivalent for both receivers in an embodiment. In an alternative embodiment, the power split is managed via a priority algorithm. In this way, the second SIM receiver is not penalized by a 50/50 power split while the MIMO receiver is in high SNR conditions.

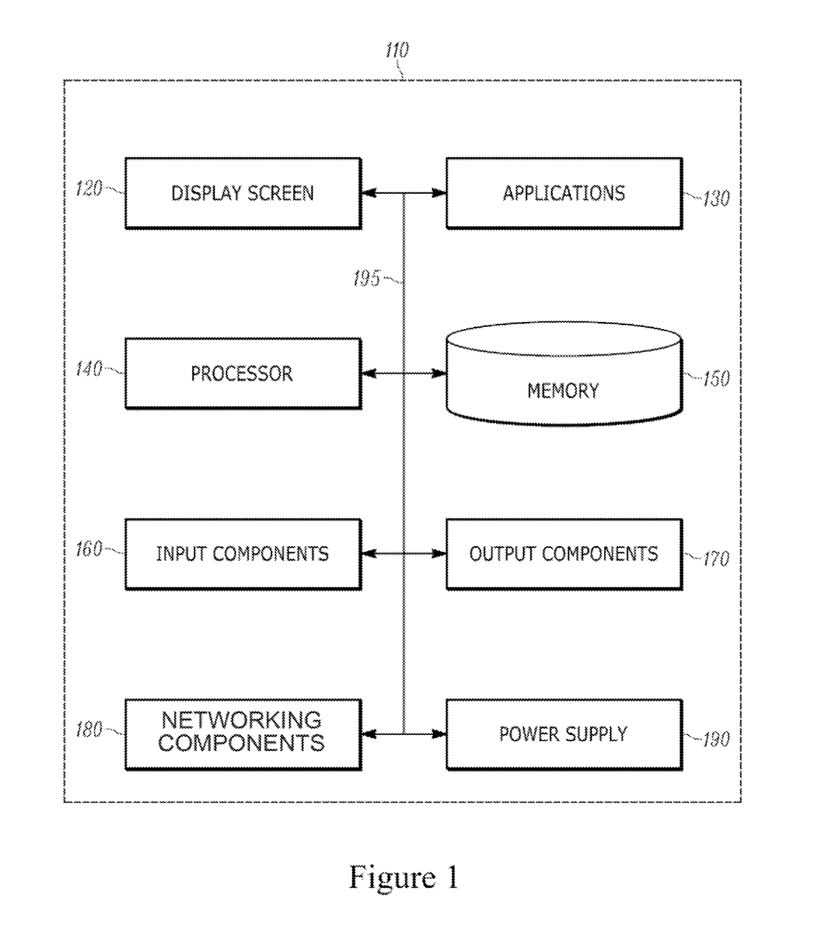

With this overview in mind, and turning now to a more detailed discussion in conjunction with the attached figures, the techniques of the present disclosure are illustrated as being implemented in a suitable computing environment. The following generalized device description is based on embodiments and examples within which the disclosed principles may be implemented and should not be taken as limiting the claims with regard to alternative embodiments that are not explicitly described herein. Thus, for example, while FIG. 1 illustrates an example mobile device within which embodiments of the disclosed principles may be implemented, it will be appreciated that other device types may be used, including but not limited to laptop computers, tablet computers, personal computers, embedded automobile computing systems, and so on.

The schematic diagram of FIG. 1 shows an exemplary device 110 forming part of an environment within which aspects of the present disclosure may be implemented. In particular, the schematic diagram illustrates a user device 110 including several exemplary components. It will be appreciated that additional or alternative components may be used in a given implementation depending upon user preference, component availability, price point, and other considerations.

In the illustrated embodiment, the components of the user device 110 include a display screen 120, applications (e.g., programs) 130, a processor 140, a memory 150, one or more input components 160 such as speech and text input facilities, and one or more output components 170 such as text and audible output facilities, e.g., one or more speakers.

The processor 140 can be any of a microprocessor, microcomputer, application-specific integrated circuit, or the like. Similarly, the memory 150 may reside on the same integrated circuit as the processor 140. Additionally or alternatively, the memory 150 may be accessed via a network, e.g., via cloud-based storage. The memory 150 may include a random-access memory or a read-only memory (i.e., a hard drive, flash memory, or any other desired type of memory device).

The information that is stored by the memory 150 can include program code associated with one or more operating systems or applications as well as informational data, e.g., program parameters, process data, etc. The operating system and applications are typically implemented via executable instructions stored in a non-transitory computer readable medium (e.g., memory 150) to control basic functions of the electronic device 110. Such functions may include, for example, interaction among various internal components and storage and retrieval of applications and data to and from the memory 150.

Further with respect to the applications, these typically utilize the operating system to provide more specific functionality, such as file-system service and handling of protected and unprotected data stored in the memory 150. Although many applications may provide standard or required functionality of the user device 110, in other cases applications provide optional or specialized functionality and may be supplied by third-party vendors or by the device manufacturer.

Finally, with respect to informational data, e.g., program parameters and process data, this non-executable information can be referenced, manipulated, or written by the operating system or by an application. Such informational data can include, for example, data that are preprogrammed into the device during manufacture, data that are created by the device or added by the user, or any of a variety of types of information that are uploaded to, downloaded from, or otherwise accessed at servers or other devices with which the device is in communication during its ongoing operation.

Although not shown in detail in FIG. 1, the device 110 includes software and hardware networking components 180 to allow communications to and from the device. Such networking components provide wireless networking functionality, although wired networking may additionally or alternatively be supported.

In an embodiment, a power supply 190, such as a battery or fuel cell, may be included for providing power to the device 110 and to its components. All or some of the internal components communicate with one another by way of one or more shared or dedicated internal communication links 195, such as an internal bus.

In an embodiment, the device 110 is programmed such that the processor 140 and memory 150 interact with the other components of the device 110 to perform a variety of functions. The processor 140 may include or implement various modules and execute programs for initiating different activities such as launching an application, transferring data, and toggling through various graphical user interface objects (e.g., toggling through various display icons that are linked to executable applications).

In an embodiment of the disclosed principles, the networking components 180 include a DSDA and MIMO antenna system to improve device network performance. As noted briefly in overview above, in an embodiment, a variable power splitter controlled by MIMO SNR detection is employed to prioritize the two paths. The splitting ratio is higher during high SNR conditions, favoring the second SIM receiver. This splitting strategy improves the host device's OTA performance, without degrading MIMO performance, since the power-split ratio does not affect the correlation coefficient. In an embodiment, the power split is equal with respect to both receivers during lower SNR conditions. In an alternative embodiment, the power split is managed via a priority algorithm. In either case, the second SIM receiver is not penalized by an equal power split when the MIMO receiver is experiencing high SNR conditions.

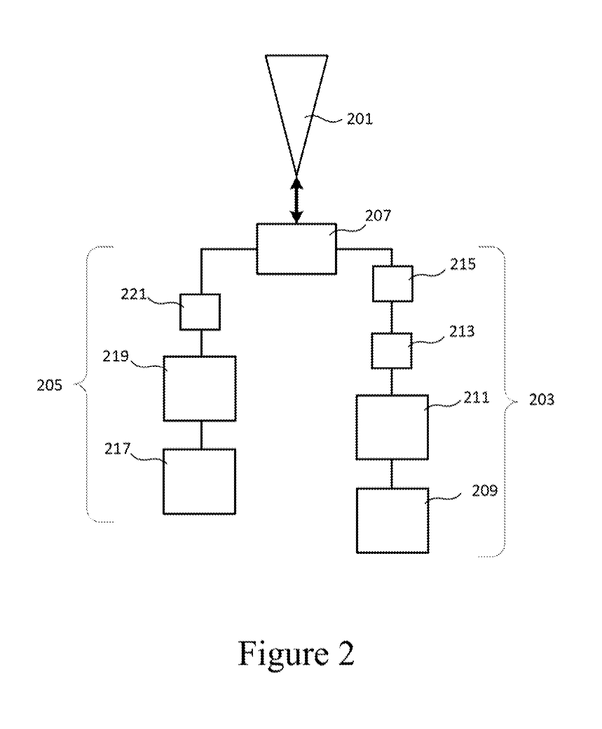

Turning to FIG. 2, an example of a traditional DSDA MIMO antenna architecture is shown schematically. In the illustrated example, the traditional DSDA MIMO antenna system includes a shared antenna 201 linked to a secondary SIM transceiver path 203 and a MIMO transceiver path 205. Typically the incoming and outgoing signal-power division between the diverse paths 203, 205 is equal, or substantially equal, in diversity mode.

A match/diplex module 207 joins both transceiver paths 203, 205 to the shared antenna 201 and serves to transmit data from both transceiver paths 203, 205 over the shared antenna 201. The match/diplex module 207 also separates incoming signals by path and provides impedance matching for each transceiver path 203, 205. For signal separation, the match/diplex module 207 may use different frequencies to transmit and receive the signals from and to different path signals at the shared antenna 201.

The secondary SIM transceiver path 203 originates, in an embodiment, at a first transceiver 209. The first transceiver 209 may be a wafer-level package or otherwise and in an embodiment accommodates dual SIM active and optional standby modes. The secondary SIM transceiver path 203 further includes signal conditioning and processing circuitry 211 such as switches, band filters, notch filters, noise rejection filters, and so on. In a particular embodiment, the secondary SIM transceiver path 203 carries primarily mid- and high-frequency signals and as such may include one or more mid- or high-frequency filters within the signal conditioning and processing circuitry 211.

The secondary SIM transceiver path 203 may further include a test tap 213 to access data in the secondary SIM transceiver path 203 for analysis. In addition, a tuner 215 may be included in the secondary SIM transceiver path 203 to tune the shared antenna 201.

Similarly, the MIMO transceiver path 205 includes, in the illustrated embodiment, a second transceiver 217 and dedicated or shared signal conditioning and processing circuitry 219. Again, such circuitry may include switches, band filters, notch filters, noise rejection filters, and other signal-modification devices. In a particular embodiment, the MIMO transceiver path 205 carries primarily low-frequency signals, and as such the signal conditioning and processing circuitry 219 may include one or more low-frequency filters. Finally, as with the secondary SIM transceiver path 203, the MIMO transceiver path 205 may include a test tap 221 for accessing data in the MIMO transceiver path 205.

As noted above, the architecture shown in FIG. 2 provides distinct benefits over prior single-path antenna architectures. Nonetheless, the illustrated architecture wastes a portion of the capabilities of the MIMO DSDA system. The MIMO antenna-gain imbalance does not appreciably affect the overall MIMO-radiated performance during high SNR conditions (e.g., SNR >12 dB) but does affect radiated performance (and resultant data throughput) during low SNR conditions (e.g., SNR <6 dB).

Coupled with this fact is the observation that a MIMO system can provide either robustness (through diversity) or increased throughput (through spatial multiplexing). When in the diversity mode, the same outgoing signal is sent via both paths, and the same purported received signal is processed through both paths. However, redundancy is not always needed for robustness of data sent via the MIMO transceiver path 205, e.g., during high SNR conditions.

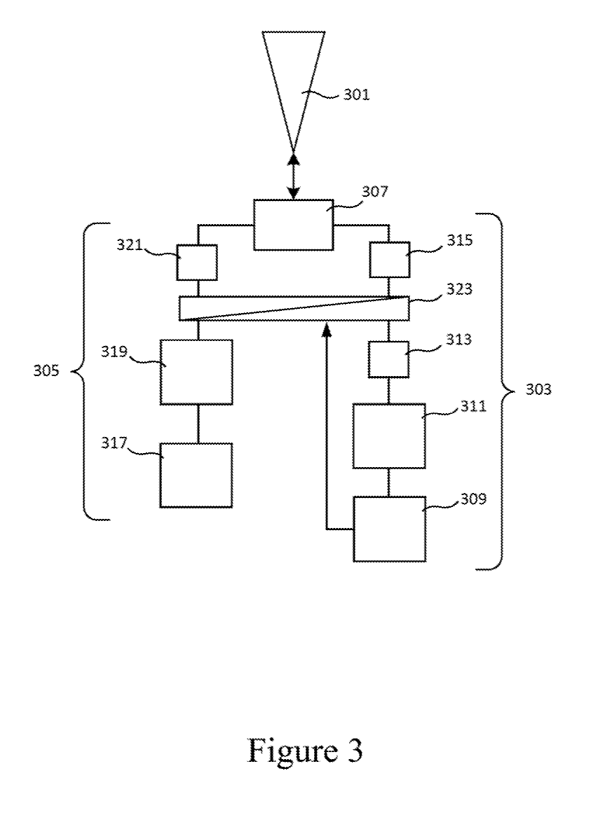

In an embodiment of the disclosed principles, the architecture of FIG. 2 is modified as shown in the schematic illustration of FIG. 3 to accommodate and leverage the variable influence of the MIMO antenna-gain imbalance on system performance and throughput. As with FIG. 2, the architecture shown in FIG. 3 includes two radio-frequency signal transceiver paths 303, 305 using a shared antenna 301. The paths include a MIMO transceiver path 305 and a secondary SIM transceiver path 303 linked by a match/diplex module 307.

Further, as with the architecture of FIG. 2, the secondary SIM transceiver path 303 includes, in an embodiment, a first transceiver 309, signal conditioning and processing circuitry 311, a test tap 313, and a tuner 315. Similarly, the MIMO transceiver path 305 includes a second transceiver 317, signal conditioning and processing circuitry 319, and a test tap 321.

However, unlike the embodiment shown in FIG. 2, the improved architecture of FIG. 3 includes variable power splitter 323 disposed before the tuner 315 in the secondary SIM transceiver path 303 as well as before the test tap 321 in the MIMO transceiver path 305. The variable power splitter 323 splits or allocates the signal fed to it between the secondary SIM transceiver path 303 and the MIMO transceiver path 305. The degree of splitting executed by the variable power splitter 323, e.g., the deviation from an even split, is set by the variable power splitter 323 based on the detected SNR.

In an embodiment, the variable power splitter 323 favors the second SIM transceiver to the extent possible to improve the OTA performance of the second SIM transceiver. For example, in high SNR conditions, the variable power splitter 323 sets the splitting ratio favorable to the second SIM transceiver, e.g., such that fewer data are carried via the secondary SIM transceiver path 303 than via the MIMO transceiver path 305. Since the SNR is high, this split improves the OTA performance of the second SIM transceiver without degrading the performance of the MIMO transceiver path 305, since the power-split ratio does not affect the correlation coefficient.

In low SNR conditions, the variable power splitter 323 favors the second SIM transceiver less or not at all. In other words, the power split may be equal or close to equal across both transceiver paths. In a further embodiment, the variable power splitter 323 or a controller thereof sets the power split based on SNR according to a priority algorithm for low SNR conditions. Thus, while the second SIM transceiver shares the transmitting and reception burden essentially equally during low SNR conditions, the MIMO path 305 is able to absorb more than half of the transmitting and reception burden during high SNR conditions.

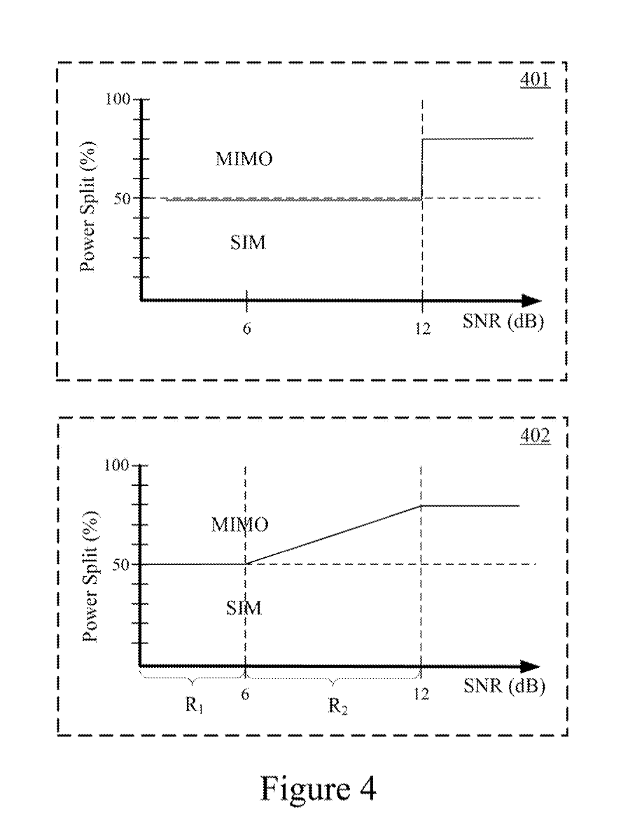

While those of skill in the art will appreciate that many SNR-based splitting strategies may be implemented within the disclosed architecture, FIG. 4 illustrates a pair of example splitting plots for clarity of understanding. In particular, the first splitting plot 401 and second splitting plot 402 of FIG. 4 illustrate the implementation of a step-function power-splitting strategy and a continuous power-splitting strategy respectively.

Turning more specifically to the first splitting plot 401, it can be seen that when the system is experiencing low- and mid-level SNR conditions, with SNR less than about 12 dB (e.g., within 2 dB of 12 dB), the variable power splitter 323 implements a 50/50% split between the paths 303, 305. However, when the SNR equals or exceeds 12 dB the variable power splitter 323 implements an 80/20 percentage split emphasizing the MIMO path 305. It will be appreciated that higher or lower split ratios may be used in any SNR magnitude range in keeping with the illustrated principles, and that a greater number of distinct ranges may be used for finer control.

The second splitting plot 402 shows the implementation of a continuous splitting strategy. In this implementation, the variable power splitter 323 implements a 50/50 percentage split between the paths 303, 305 for low SNR conditions, e.g., in the range R₁. However, when the SNR is between 6 dB and 12 dB in the illustrated example, the variable power splitter 323 implements a gradually increasing split emphasizing the MIMO path 305 in range R₂. At SNRs above 12 dB, the variable power splitter 323 implements a constant percentage split between the paths 303, 305. While the illustrated increase between 6 dB and 12 dB is linear, it will be appreciated that the change in power split need not be a linear or smooth function of SNR. In cases where a split is calculated based on other factors in addition to the SNR, the change in split with increasing SNR may not be monotonic.

While the term “calculate” is used above for the sake of simplicity to indicate determining a split ratio, the manner of obtaining the split ratio is not limited to numerical calculation. For example, empirically determined optimal split ratios may be tabulated as a function of SNR. Obtaining an appropriate split ratio in this case would entail identifying the split ratio via a table lookup. Similarly, other methods may be employed for resolving a split ratio as a function of SNR in keeping with the disclosed principles.

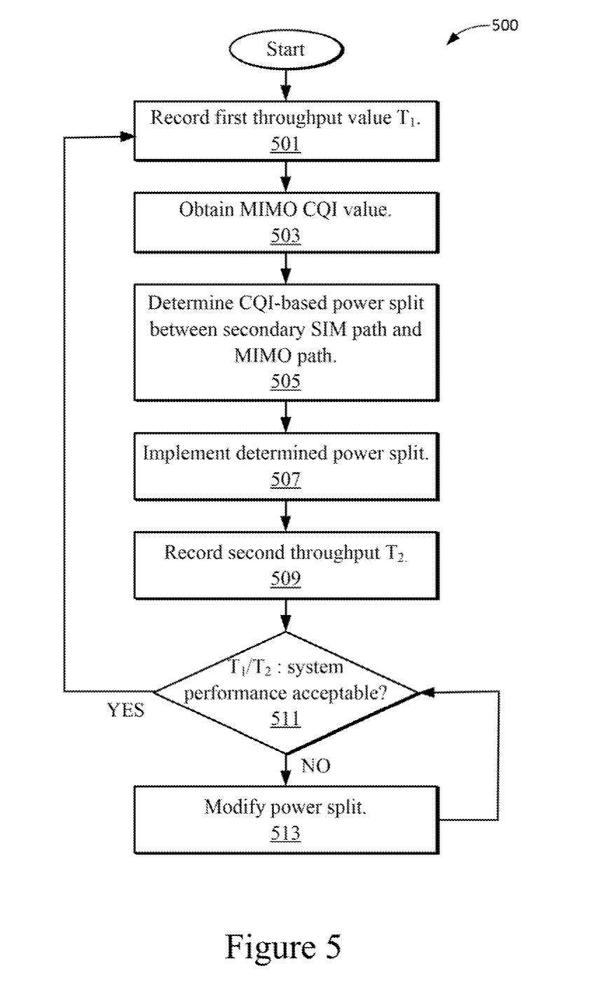

FIG. 5 is a flowchart explaining an example process 500 of implementing a power split between paths in a DSDA MIMO antenna system in accordance with certain embodiments of the disclosed principles. While the illustrated process 500 assumes a system architecture similar to that shown in FIG. 3, it will be appreciated that changes may be made in the described architecture and process 500 without necessarily departing from the described principles.

At stage 501 of the process 500, the mobile device reads the instantaneous CQI value and records it as T₁ for the DSDA MIMO antenna system. Proceeding to stage 503, the system generates an equivalent CQI value. Given the CQI value, the variable power splitter 323 determines a suitable CQI-based power split between the secondary SIM path 303 and the MIMO path 305 at stage 505. As noted above, the suitable CQI-based power split may be calculated based on an algorithm, in which case the algorithm, or certain of its parameters, may be adaptive or predetermined. Likewise, the suitable CQI-based power split may be determined via a CQI-coding rate lookup table or other suitable means.

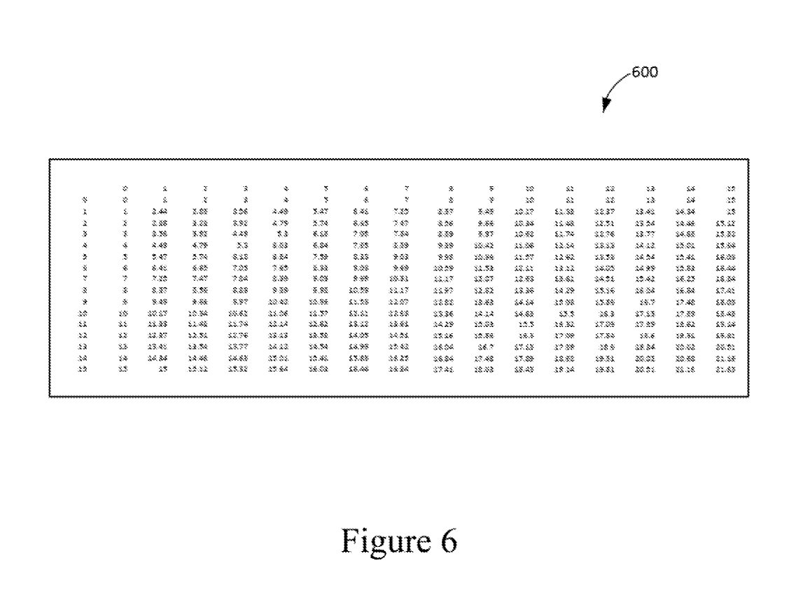

FIG. 6 provides an example of a type of lookup table 600 that may be used in an embodiment of the disclosed principles. In the context of long-term evolution (“LTE,” sometimes referred to as “4G LTE”), there are 15 different possible CQI values, in addition to a value of 0 which indicates no transmission. The illustrated lookup table 600 is indexed by the CQI values for each channel, with the CQI value of each channel independently ranging from 0 to 15. At the intersection of each potential CQI value pairing in the table 600, an effective CQI value, defining an appropriate power split, is listed. For low CQI in either the MIMO or SIM channel, the effective CQI is the CQI of the other channel, indicating an even split. For mid-to-high CQI values on both channels, the effective CQI is slightly greater than the CQI of either channel, indicating a split ratio increasingly in favor of leveraging the MIMO channel to a greater degree.

Returning to FIG. 5, the variable power splitter 323 implements the determined power split at stage 507, and proceeds to stage 509, wherein the variable power splitter 323 records a second CQI value T₂ for the DSDA MIMO antenna system. The first CQI value T₁ and second CQI value T₂ are compared at stage 511 to determine if system performance remains acceptable. Whether system performance is acceptable may be measured by whether the system throughput has decreased, or decreased by more than a certain amount or proportion, under the new power split.

If the system performance is acceptable, then the variable power splitter 323 returns to stage 501. Otherwise, the process 500 modifies the power split at stage 513 and returns to stage 511. Once system performance is acceptable, the process 500 then returns to stage 501.

It will be appreciated that various systems and processes for improving system performance in DSDA MIMO antenna systems have been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A mobile communication device comprising:
a first antenna;
a second antenna;
a primary subscriber identification module (“SIM”) linked to the first antenna;
a diplex module;
a secondary SIM and a secondary SIM transceiver path linking the secondary SIM to the second antenna via the diplex module;
a multiple-input, multiple-output (“MIMO”) transceiver path also linked to the second antenna via the diplex module, such that each of the secondary SIM transceiver path and MIMO transceiver path provide radio-frequency (“RF”) data to the diplex module and receive RF information from the diplex module; and
a power splitter disposed in the secondary SIM transceiver path and configured to adaptively set a power split between the MIMO transceiver path and the secondary SIM transceiver path based on a current signal-to-noise (“SNR”) value associated with the MIMO transceiver path.

2. The mobile communication device of claim 1 wherein the power splitter is a variable splitter.

3. The mobile communication device of claim 2 wherein the power splitter is configured to set the power split between the MIMO transceiver path and the secondary SIM transceiver path as a step function of the current SNR value associated with the MIMO transceiver path over a least a portion of the available SNR range.

4. The mobile communication device of claim 2 wherein the power splitter is configured to set the power split between the MIMO transceiver path and the secondary SIM transceiver path as a continuous function of the current SNR value associated with the MIMO transceiver path over a least a portion of the available SNR range.

5. The mobile communication device of claim 2 wherein the power splitter is configured to maintain an equal division between the MIMO transceiver path and the secondary SIM transceiver path over a least a portion of the available SNR range.

6. The mobile communication device of claim 5 wherein the power splitter is configured to increase the power in the MIMO transceiver path relative to that in the secondary SIM transceiver path when the current SNR value exceeds a predetermined threshold value.

7. The mobile communication device of claim 6 wherein the predetermined threshold value is about 12 dB.

8. The mobile communication device of claim 1 wherein the power splitter is further configured to modify the power split based on a measured throughput of at least one of the MIMO transceiver path and the secondary SIM transceiver path.

9. The mobile communication device of claim 1 wherein the power splitter is configured to adaptively set a power split between the MIMO transceiver path and the secondary SIM transceiver path based on the current SNR value associated with the MIMO transceiver path by performing a table look up.

10. The mobile communication device of claim 1 wherein the power splitter is configured to adaptively set a power split between the MIMO transceiver path and the secondary SIM transceiver path based on the current SNR value associated with the MIMO transceiver path by calculating the power split.

11. A method of antenna-use management in a mobile communication device having first and second antennas, a primary subscriber identification module (“SIM”) linked to the first antenna, a diplex module, a secondary SIM transceiver path linked to the second antenna via the diplex module, a multiple-input, multiple-output (“MIMO”) transceiver path also linked to the second antenna via the diplex module, and a power splitter disposed in the secondary SIM transceiver path, the method comprising:
detecting a current signal-to-noise ratio (“SNR”) value associated with the MIMO transceiver path;
generating a power split value based on the current SNR value; and
applying the generated power split value at the power splitter to apportion signal power between the MIMO transceiver path and the secondary SIM transceiver path.

12. The method of claim 11 wherein the power splitter is a variable splitter.

13. The method of claim 12 wherein generating the power-split value based on the current SNR value comprises generating the power split based on a step function of the current SNR value.

14. The method of claim 12 wherein generating the power-split value based on the current SNR value comprises generating the power split based on a continuous function of the current SNR value.

15. The method of claim 12 wherein generating the power-split value based on the current SNR value comprises setting the power-split value to allow an equal division between the MIMO transceiver path and the secondary SIM transceiver path over a least a portion of the available SNR range.

16. The method of claim 15 further comprising increasing the power in the MIMO transceiver path relative to that in the secondary SIM transceiver path when the current SNR value exceeds a predetermined threshold value.

17. The method of claim 16 wherein the predetermined threshold value is about 12 dB.

18. The method of claim 11 wherein generating the power-split value based on the current SNR value comprises performing a table look up.

19. The method of claim 11 wherein generating the power-split value based on the current SNR value comprises calculating the power split.

20. A mobile communication device comprising:
an antenna;
a first transceiver path linked to the antenna;
a second transceiver path linked to the antenna; and
a power splitter configured to adaptively set a power split between the first and second transceiver paths based on a current signal-to-noise value associated with one of the first and second transceiver paths.
